(19) United States
(12) Patent Application Publication
(10) Pub. No.: US 2003/0061762 A1
(43) Pub. Date: Apr. 3, 2003

(54) Floral display device

(76) Inventor: Pete F. Garcia, Atlanta, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/289,955

(22) Filed: Nov. 7, 2002

Related U.S. Application Data
(62) Division of application No. 09/957,335, filed on Sep. 20, 2001.

(51) Int. Cl. A01G 9/02

(52) U.S. Cl. 47/65.7

(57) ABSTRACT

A floral display device includes a tapered foam body and a ballast embedded within the foam body. The ballast is positioned near a lower portion of the foam body and has a density which is substantially greater than that of the foam body. In this way, the center of gravity of the device is lower than without the ballast and the total mass is greater, rendering the device less likely to tip over. In one embodiment, the ballast is molded within a closed interior chamber of the foam body. In another embodiment, the ballast is provided in a recess in the underside of the foam body. In one form, the invention comprises a foam flowerpot which is hollow and defines an open interior region for receiving dirt, plants, etc. In another form, the invention comprises a solid floral arrangement base for receiving plant stems and flower stems to be inserted therein and has an external shape similar to that of a flowerpot, but is solid, not hollow.

### TECHNICAL FIELD

The present invention relates generally to flower containers and in particular relates to molded foam flowerpots and molded foam for use as a base for floral arrangements.

### BACKGROUND OF THE INVENTION

Traditional flowerpots are made of clay and have a generally frusto-conical shape with the smaller end being the bottom and the larger end being the top. Because of this inverted arrangement, with the larger end being on top and the smaller end being the base, the shape is somewhat unstable and tends to tip over. However, because the flowerpot is traditionally made of clay, the heavy clay construction provides some stability against tipping over.

In recent years, it has become somewhat common to make flowerpots out of lightweight plastic. While the use of plastic has the useful advantages of being lightweight and inexpensive, it does make the flowerpot somewhat more unstable. Note that as flowers or plants are placed in the flowerpot, the flowers or plants can tend to tip the lightweight plastic flowerpot over. Thus, a need remains for a flowerpot which has the advantages of a flowerpot, but with added stability.

In the past, it also has been common to use a piece of plastic foam block as a base for creating a decorative floral arrangement. In this regard, the stems of flowers or plants are pushed into the foam base. However, foam is generally very lightweight and the weight of the plant stems or flower stems often can easily topple the arrangement over onto its side. Accordingly, there is also a need for a floral arrangement base with improved stability.

There being a need yet in the industry for an improved flowerpot and an improved floral arrangement base, the present invention is primarily directed to meeting this need.

### SUMMARY OF THE INVENTION

Briefly described, in a first preferred form the present invention comprises a floral display device including a foam body and a ballast embedded within the foam body. The ballast is positioned near a lower portion of the foam body and has a density which is substantially greater than that of the foam body. In this way, the mass of the device is made greater and the center of gravity of the floral arrangement is made lower than without the ballast, rendering the device less likely to tip over.

Preferably, the ballast is molded within the interior chamber of the foam body. Also preferably, the ballast comprises a loose aggregate material, such as sand. Alternatively, the ballast can comprise a unitary molded element, such as a small disk of metal or other dense material. As an alternative to molding the ballast within the interior of the foam body, it is possible to provide a recess in the underside (or elsewhere) of the foam body and a ballast can be secured in the recess. However, molding the ballast into the interior of the foam body allows for easy and secure use of a loose aggregate material.

In one form, the invention comprises a foam flowerpot which is generally hollow and defines an open interior region for receiving dirt, plants, etc. In another form, the present invention comprises a solid floral arrangement base for receiving plant stems and flower stems to be inserted directly therein. Preferably, the floral arrangement base has an external shape similar to that of a flowerpot, but is solid instead of hollow.

### BRIEF DESCRIPTION OF THE DRAWING FIGURES

FIG. 1 is a perspective, partially cutaway illustration of a floral display device according to a first preferred form of the invention.

FIG. 2 a sectional view of the floral display device of FIG. 1.

FIG. 3 is perspective illustration of a ballast portion of the floral display device of FIG. 1.

FIG. 4 is a perspective illustration of a loose, non-unitary ballast which optionally can be used in place of the ballast of FIG. 3.

FIG. 5 is a sectional view of a floral display device according to a second preferred form of the invention.

FIG. 6 is a perspective illustration of a floral display device according to a third preferred form of the invention.

FIG. 7 a sectional view of the floral display device of FIG. 6.

### DETAILED DESCRIPTION OF THE PREFERRED EMBODIMENTS

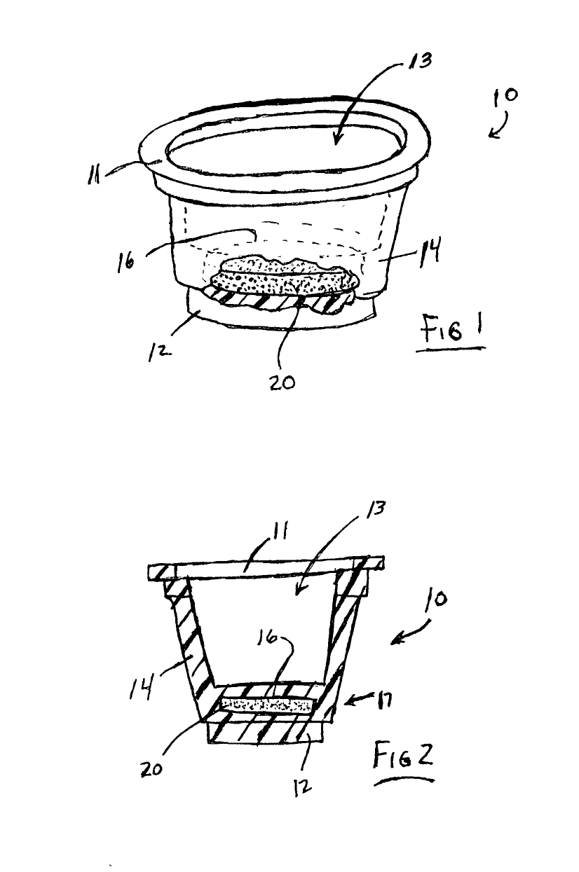

Referring now in detail to the drawing figures, wherein like reference numerals represent like parts throughout the several views, FIG. 1 shows a floral display device 10 according to a preferred form of the invention. The floral display device 10 is in the form or shape of a flowerpot. In other words, the display device 10 has a generally frustoconical shape. The display device 10 is hollow and includes an upper lip or flange 10.1 and a lower base 12. The hollow display device 10 defines an open interior region indicated generally at 13 for receiving plants, flowers, potting material, etc. therein. The tapered sidewall 14 extends between the upper flange 11 and the lower base 12. The upper flange 11, the lower base 12, and the sidewall 14 are made from a lightweight foam, such as expanded-polystyrene. Those skilled in the art will recognize that other lightweight materials can be employed, such as expanded polyureathane, as well as other foams.

As described above, a lightweight flowerpot or floral container generally has the unwanted disadvantage of tending to tip over. To counteract this tendency, the floral display device 10 according to the present invention includes a ballast 20. The ballast 20 as depicted in FIG. 1 and FIG. 2 comprises a collection of granular, dense material, such as small metal shot. For this purpose any dense shot can be used, such as cast iron shot, sand, or any other loose, aggregate material which has a density substantially greater than that of the foam in order to provide the ballast weight which tends to keep the floral display device 10 upright. In the embodiment depicted in FIG. 1 and FIG. 2, the ballast 20 is received within an interior chamber 16 formed in the lower portion 17 of the floral display device 10. In the specific device depicted, the chamber 16 is generally a short, squat cylinder, similar in shape to a hockey puck. Those skilled in the art will readily recognize, however, that other shapes can be employed with as good or nearly as good results. One advantage to having the ballast received within an interior chamber of the display device solid, unitary ballast 220 securely therein.

While the invention has been disclosed in preferred forms for illustration purposes, those skilled in the art will readily recognize that many modifications, additions, and deletions can be made therein without departing from the spirit and scope of the invention as set forth in the following claims. 10 is that the ballast is then securely captured within the foam display device. This conveniently allows for the use of the loose aggregate ballast, which can be a waste product (and therefore relatively inexpensive), without fear that the loose aggregate ballast will spill out.

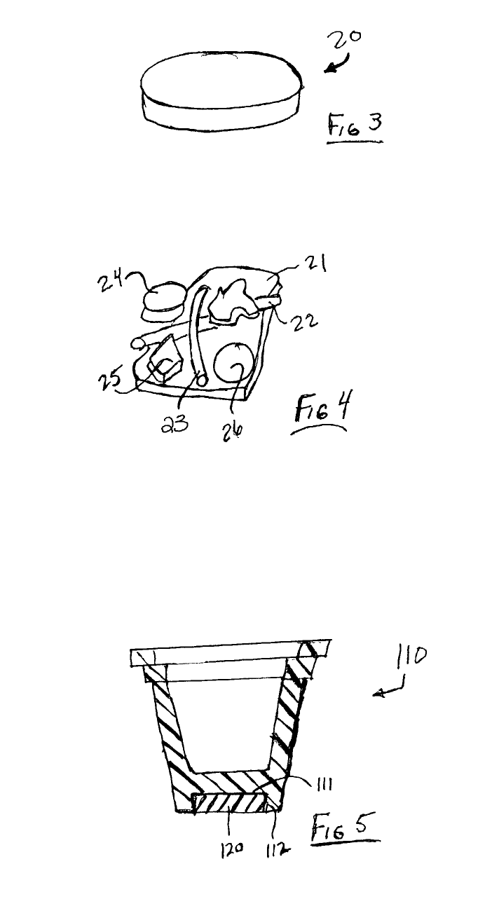

Referring now to FIG. 3, the ballast 20 alternatively can be seen to be in the form of a solid material, similar in shape to a hockey puck. The disk or short cylinder 20 making up the ballast can be a solid cast, molded or otherwise formed block of dense material. For example, the ballast 20 can be a molded block of lead. While a puck shape is depicted, other shapes can be employed with equally good results.

As shown in FIG. 4, the unitary ballast 20 can be replaced with irregularly-shaped pieces of dense material. In this way, readily available scrap materials can be used to provide the ballast. Here, the ballast depicted for example comprises a largish chunk 21, some strands 22 and 23, and some other loose pieces 24, 25, and 26.

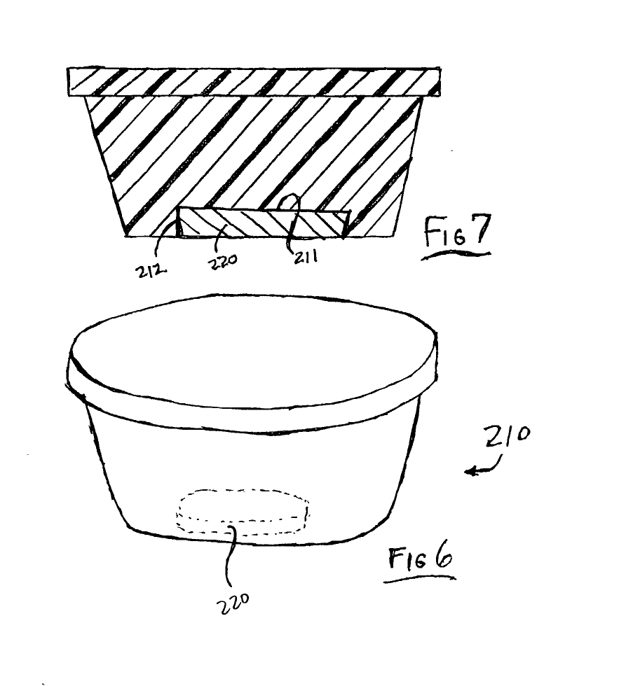

Referring now to FIG. 5, an alternate form of the present invention is depicted. As shown in FIG. 5, a floral display device 1 10 has a similar overall shape to the floral display device 10 of FIG. 1. However, here the floral display device 110 defines a lower recess 111 for receiving a unitary ballast 120. The recess 111 includes tapered sidewalls 112 for helping to secure the ballast 120 within the recess. Additionally, adhesives or other fastening techniques can be used to help secure the ballast 120 within the recess 111. One advantage to the arrangement depicted in FIG. 5 is that the ballast can be easily added after the molding of the basic container. Depending upon one's manufacturing capabilities, it may be desirable to mold the ballast in place as depicted in FIG. 1 or to add the ballast after the foam is molded.

Referring now to FIG. 6 and FIG. 7, another floral display device 210 is depicted, again having the overall exterior shape of a flowerpot. However, here the floral display device 210 is solid, rather than being hollow. The display device 210 can be used by itself for receiving flower stems and plant stems stuck therein or can be placed inside of another container, such as a flowerpot, again for receiving flower stems or plant stems for creating a floral arrangement. Similar to the arrangement of FIG. 5, the solid floral display device 210 includes a slightly tapered lower recess 211 with tapered sides 212 for receiving a

I claim:

1. A floral display device comprising:
a hollow, generally tapered foam body; and
a ballast embedded within said foam body near a lower portion thereof, said ballast having a density which is substantially greater than that of said foam body.

2. The floral display device as claimed in claim 1 wherein said ballast comprises a loose aggregate.

3. A floral display device is claiming claim 1 wherein said ballast comprises a unitary element.

4. A floral display device is claiming claim 1 wherein said ballast is positioned in an open recess formed in an underside of said foam body.

5. A floral display device is claiming claim 1 wherein said ballast is positioned in a closed chamber formed within an interior of said foam body near a bottom portion thereof.

6. A floral display device comprising a:
a generally tapered foam body; and
a ballast embedded within said foam body near a lower portion thereof, said ballast having a density which is substantially greater than that of said foam body.

7. A floral display device as claimed in claim 6 wherein said foam body is solid and generally tapered.

8. A floral display device as claimed in claim 6 wherein said foam body is hollow and generally tapered.

9. The floral display device as claimed in claim 6 wherein said ballast comprises a loose aggregate.

10. A floral display device as claimed in claim 6 wherein said ballast comprises a unitary element.

11. A floral display device is claiming claim 6 wherein said ballast is positioned in an open recess formed in an underside of said foam body.

12. A floral display device is claiming claim 6 wherein said ballast is positioned in a closed chamber formed within an interior of said foam body near a bottom portion thereof.

13. A floral display device comprising a:
a generally tapered foam body having an open recess formed in a lower portion thereof; and
a ballast embedded within said open recess of said foam body, said ballast having a density which is substantially greater than that of said foam body.

14. A floral display device as claimed in claim 13 wherein said generally tapered foam body is solid.

15. A floral display device as claimed in claim 13 wherein said generally tapered foam body is hollow.

16. A floral display device as claimed in claim 13 wherein said ballast comprises a unitary element.
